(19) United States
(12) Patent Application Publication
(10) Pub. No.: US 2013/0091372 A1
(43) Pub. Date: Apr. 11, 2013

(54) CONTROL DEVICE AND COMPUTER PROGRAM PRODUCT

(71) Applicants: Tetsuro Kimura, Tokyo (JP); Tatsunori Kanai, Tokyo (JP); Haruhiko Toyama, Tokyo (JP); Koichi Fujisaki, Tokyo (JP); Hiroyoshi Haruki, Tokyo (JP); Masaya Tarui, Tokyo (JP); Satoshi Shirai, Tokyo (JP); Akihiro Shibata, Tokyo (JP)

(72) Inventors: Tetsuro Kimura, Tokyo (JP); Tatsunori Kanai, Tokyo (JP); Haruhiko Toyama, Tokyo (JP); Koichi Fujisaki, Tokyo (JP); Hiroyoshi Haruki, Tokyo (JP); Masaya Tarui, Tokyo (JP); Satoshi Shirai, Tokyo (JP); Akihiro Shibata, Tokyo (JP)

(73) Assignee: KABUSHIKI KAISHA TOSHIBA, Tokyo (JP)

(21) Appl. No.: 13/622,514

(22) Filed: Sep. 19, 2012

(30) Foreign Application Priority Data
Sep. 22, 2011 (JP) 2011-207133

(51) Int. Cl. G06F 1/30

(52) U.S. Cl. 713/340

(57) ABSTRACT

According to an embodiment, a control device includes a receiving unit, a judging unit, an estimating unit, a deciding unit, a directing unit, and a sending unit. The receiving unit is configured to receive an interrupt request requesting a processing device that includes elements capable of being individually subjected to voltage control to execute an interrupt process. The judging unit is configured to judge a state of the elements. The estimating unit is configured to estimate a start-up time for the element to change into an operating mode after power is supplied. The deciding unit is configured to decide a starting point in time at which power supply is to be started on basis of a difference in the start-up times between the elements. The directing unit is configured to direct a power supply unit for supplying power to the elements. The sending unit is configured to send the interrupt request.

### CROSS-REFERENCE TO RELATED APPLICATION

This application is based upon and claims the benefit of priority from Japanese Patent Application No. 2011-207133, filed on Sep. 22, 2011; the entire contents of which are incorporated herein by reference.

### FIELD

Embodiments described herein relate generally to a control device and a computer program product.

### BACKGROUND

In related art, known is a technique of making a processing device (such as a processor) execute an interrupt process associated with a received interrupt request requesting the processing device to execute an interrupt process each time an interrupt request is received. In such a technique, when the processing device receives an interrupt request during an idle state in which the processing device is not executing any processes, the processing device changes from the idle state into an active state in which the processing device can execute the interrupt process. After executing the interrupt process, the processing device changes again into the idle state.

As an example of methods for reducing the power consumption of the processing device, a method of reducing power being supplied to the processing device in the idle state to change the processing device to a power-saving state (sleep state) can be considered. In this case, power supply to the processing device is resumed when an interrupt request is received. Then, after the processing device is changed to an operable state, the interrupt process is executed. After the power supply is resumed, however, the time (start-up time) required for a plurality of elements constituting the processing device to change into operable states varies depending on the elements. Thus, if power supply to all the elements is started at the same time, elements with shorter start-up times will remain in waiting states after completing the change to the operable states until elements with longer start-up times change to the operable states, and there is a disadvantage that the power consumption during the waiting states will be wasted.

### BRIEF DESCRIPTION OF THE DRAWINGS

FIG. 1 is a block diagram illustrating an example of a control device according to a first embodiment;

FIG. 2 is a block diagram illustrating an example of a judging unit according to the first embodiment;

FIG. 3 is a block diagram illustrating an example of the judging unit according to the first embodiment;

FIG. 4 is a diagram illustrating an example of data stored in a first storage unit according to the first embodiment;

FIG. 5 is a diagram for explaining an example of a method for deciding a starting point in time according to the first embodiment;

FIG. 6 is a flowchart illustrating an example of processing operation of the control device according to the first embodiment;

FIG. 7 is a block diagram illustrating an example of a control device according to a second embodiment;

FIG. 8 is a block diagram illustrating an example of a trigger unit according to the second embodiment;

FIG. 9 is a diagram illustrating an example of information stored in a second storage unit according to the second embodiment;

FIG. 10 is a diagram illustrating an example of information stored in the second storage unit according to the second embodiment;

FIG. 11 is a diagram illustrating an example of information stored in the second storage unit according to the second embodiment;

FIG. 12 is a diagram illustrating an example of a permission condition stored in a third storage unit according to the second embodiment;

FIG. 13 is a diagram illustrating an example of the permission condition stored in the third storage unit according to the second embodiment;

FIG. 14 is a flowchart illustrating an example of a permission process performed by a control unit according to the second embodiment;

FIG. 15 is a diagram for explaining an example of a method for deciding a starting point in time according to the second embodiment;

FIG. 16 is a block diagram illustrating an example of the control device according to a second embodiment;

FIG. 17 is a block diagram illustrating an example of a supply capacity detecting unit according to a third embodiment;

FIG. 18 is a block diagram illustrating an example of the supply capacity detecting unit according to a third embodiment;

FIG. 19 is a diagram illustrating an example of a permission condition stored in a third storage unit according to the third embodiment;

FIG. 20 is a block diagram illustrating an example of a control device according to a modified example; and

FIG. 21 is an explanatory diagram of a modified example.

### DETAILED DESCRIPTION

According to an embodiment, a control device includes a receiving unit, a judging unit, an estimating unit, a deciding unit, a directing unit, and a sending unit. The receiving unit is configured to receive an interrupt request requesting a processing device that includes a plurality of elements capable of being individually subjected to voltage control to execute an interrupt process. The judging unit is configured to judge a state of each of the elements. The estimating unit is configured to estimate, for each of the elements, a start-up time representing a time required for the element to change into an operating mode representing an operable state after power is supplied on basis of a result of judgment by the judging unit. The deciding unit is configured to decide, for each of the elements, a starting point in time representing a timing at which power supply is to be started on basis of a difference in the start-up times between the elements. The directing unit is configured to direct a power supply unit for supplying power to the elements to perform power supply according to the starting point decided by the deciding unit. The sending unit is configured to send the interrupt request to the processing device.

First Embodiment

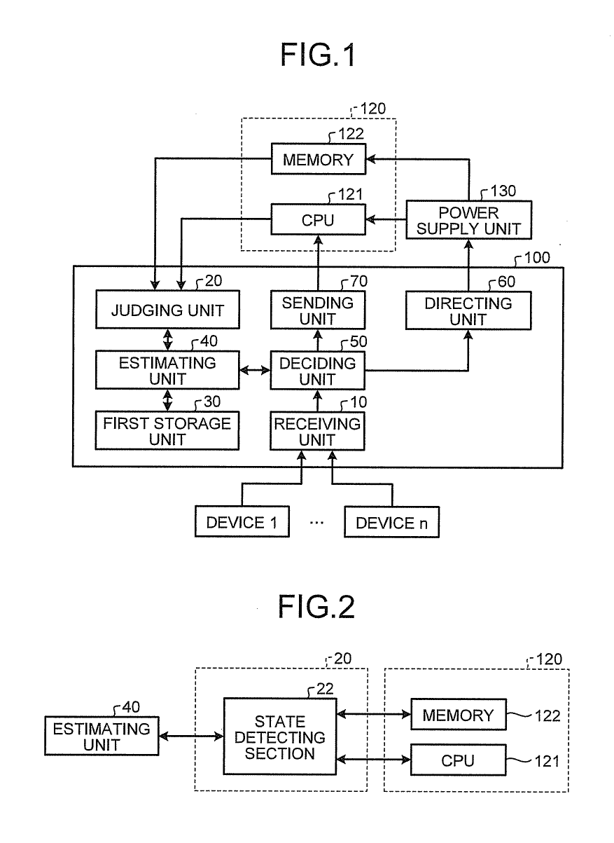

FIG. 1 is a block diagram illustrating an example of a schematic configuration of a control device 100 according to a first embodiment. The control device 100 receives an interrupt request requesting a processing device 120 to execute an interrupt process from each of a plurality of devices 1 to n, and sends the received interrupt request to the processing device 120. The devices are devices each having at least one of a function of inputting data externally to the processing device 120 and a function of outputting data to outside from the processing device 120, and examples thereof include a keyboard, a HDD, a network interface unit, and a timer. The processing device 120 may include a central processing unit (CPU) 121 and a memory 122, for example.

In an idle state in which no process is executed, the processing device 120 according to this embodiment changes into a power-saving state (sleep state) in which power supply to a plurality of elements constituting the processing device 120 is reduced. The elements can be individually subjected to voltage (power supply) control. Examples of the elements include components or sections in components that can be individually subjected to voltage control. For example, a section in the CPU 121, the memory 122 or a system-on-chip (SOC) including the CPU 121 can be an element. The voltage control includes control of switching the voltage on/off. Note that any of the devices described above can be an element of the processing device 120. In this embodiment, when the control device 100 receives an interrupt request, the control device 100 estimates the time required for changing each of a plurality of elements (such as the CPU 121 and the memory 122) constituting the processing device 120 to an operating mode representing a state in which the element can operate after power is supplied thereto on the basis of the current state each element. The control device 100 then decides a starting point in time representing a timing at which power supply for changing each element to the operating mode is started on the basis of a difference between start-up times of the elements. The control device 100 then directs a power supply unit 130 for supplying power to each of the elements constituting the processing device 120 to perform power supply according to the decided starting point. Specific details will be hereinafter described. Note that the power supply unit 130 according to this embodiment supplies power from a battery (not illustrated) to each of the elements constituting the processing device 120 under the control of the control device 100.

As illustrated in FIG. 1, the control device 100 includes a receiving unit 10, a judging unit 20, a first storage unit 30, an estimating unit 40, a deciding unit 50, an directing unit 60 and a sending unit 70. The respective units (10, 20, 30, 40, 50, 60 and 70) of the control device 100 herein are constituted by semiconductor integrated circuits. Alternatively, some of the units of the control device 100 may be implemented by software. For example, the first storage unit 30 may be constituted by hardware and functions of the receiving unit 10, the judging unit 20, the estimating unit 40, the deciding unit 50, the directing unit 60 and the sending unit 70 may be implemented by executing control programs by a CPU mounted on the control device 100.

The receiving unit 10 receives an interrupt request from each of a plurality of devices 1 to n. The judging unit 20 judges the state of each of the elements (such as the CPU 121 and the memory 122) constituting the processing device 120. In this embodiment, the “operating mode” representing a state in which an element can operate and an “inactive mode” representing a state in which the operation of the element is stopped and in which power consumption is saved as compared to the operating mode are set as examples of modes representing the states of each element. In this example, the “operating mode” includes both of a state in which an element is waiting in an operable state and a state in which the element is actually operating.

The judging unit 20 may include a state detecting section 22 as illustrated in FIG. 2, for example. In the example of FIG. 2, the state detecting section 22 detects (judges) in which of the operating mode and the inactive mode each of the elements constituting the processing device 120 is by monitoring accesses to or signal lines of the element in response to a request from the estimating unit 40.

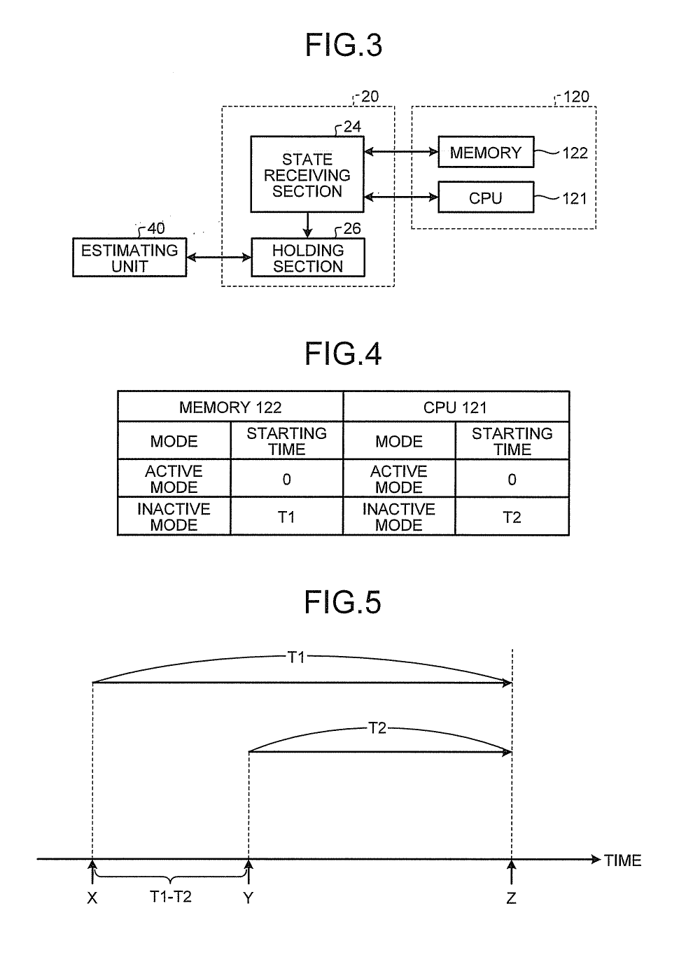

Alternatively, the judging unit 20 may include a state receiving section 24 and a holding section 26 as illustrated in FIG. 3, for example. In the example of FIG. 3, each of the elements constituting the processing device 120 sends a state change signal informing a change in the state to the state receiving section 24 when the element changes from the operating mode to the inactive mode or from the inactive mode to the operating mode. The state receiving section 24 judges whether the element is in the operating mode or the inactive mode on the basis of the state change signal received from the element. The state receiving section 24 then cause state information representing the state (the operating mode or the inactive mode) of each element to be held by the holding section 26. The state information held by the holding section 26 is updated each time the state receiving section 24 receives the state change signal described above. In the example of FIG. 3, the estimating unit 40 can know the state of each element by reading the state information held by the holding section 26. The state change signal may be individually sent by each device or may be collectively sent by the CPU 121.

The description is continued referring back to FIG. 1. The first storage unit 30 stores for each element the mode representing the state of the element in association with the start-up time representing the time required to change to the operating mode after power is supplied. FIG. 4 is a diagram illustrating an example of the data stored in the first storage unit 30. In the example of FIG. 4, a start-up time associated with the “operating mode” of the memory 122 is “0” while a start-up time associated with the “inactive mode” of the memory 122 is T1. In addition, in the example of FIG. 4, a start-up time associated with the “operating mode” of the CPU 121 is “0” while a start-up time associated with the “inactive mode” of the CPU 121 is T2 (T1>T2 as an example herein).

The estimating unit 40 estimates the start-up time of each of a plurality of elements (such as the CPU 121 and the memory 122) constituting the processing device 120 on the basis of the judgment result of the judging unit 20. More specifically, the estimating unit 40 estimates the start-up time of each of the elements constituting the processing device 120 by reading the start-up time associated with the current mode (state) of the element from the first storage unit 30.

The deciding unit 50 decides the starting point representing a timing at which power supply for changing each of the elements (such as the CPU 121 and the memory 122) constituting the processing device 120 to the operating mode on the basis of a difference between the start-up times of the elements. More specifically, the deciding unit 50 decides the starting point of each element so that the starting points of elements other than a reference element, which represents an element with the longest start-up time of a plurality of elements, are later than the starting point of the reference element according to differences between the start-up time of the reference element and the start-up times of the other elements. For example, assumed is a case in which the modes of the CPU 121 and the memory 122 are the inactive modes, the start-up times of the CPU 121 and the memory 122 are identified as T2 and T1, respectively. In this case, the reference element is the memory 122. Then, as illustrated in FIG. 5, the deciding unit 50 decides the starting points of the elements so that the starting point Y of the CPU 121 is later than the starting point X of the memory 122 according to the difference between the start-up time T1 of the memory 122 and the start-up time T2 of the CPU 121. In the example of FIG. 5, since the deciding unit 50 decides the starting points of the elements so that the time (hereinafter referred to as a “return completion time”) at which each element complete changing to the operating mode is the same time Z, the starting point Y of the CPU 121 is later than the starting point X of the memory 122 by a time T1−T2 corresponding to the difference between the start-up time T1 of the memory 122 and the start-up time T2 of the CPU 121.

The directing unit 60 directs the power supply unit 130 to perform power supply according to the starting points decided by the deciding unit 50. In this embodiment, the deciding unit 50 sends a specifying signal that specifies an element to which power supply is to be started each time the starting point of an element is reached, and the directing unit 60 thus sends to the power supply unit 130 a return signal directing to start power supply for changing the element specified by the specifying signal to the operating mode each time the directing unit 60 receives the specifying signal from the deciding unit 50. For example, in the example of FIG. 5, since the deciding unit 50 sends a specifying signal specifying the memory 122 as an element to which power supply is to be started to the directing unit 60 when the starting point X is reached, the directing unit 60 that has received the specifying signal sends a return signal for the memory 122 to the power supply unit 130. Then, the power supply unit 130 that has received the return signal starts power supply to the memory 122 so that the memory 122 changes to the operating mode.

Although the deciding unit 50 sends a specifying signal specifying an element to which power supply is to be started to the directing unit 60 each time a starting point of each element is reached in this embodiment, the deciding unit 50 may alternatively notify the directing unit 60 of the starting points of the elements in advance and the i directing unit 60 may send a return signal of each element to the power supply unit 130 each time the starting point of the element is reached, for example. Basically, the directing unit 60 may have any function that directs the power supply unit 130 to perform power supply according to the starting points decided by the deciding unit 50.

The sending unit 70 sends the interrupt request received by the receiving unit 10 to the processing device. In this embodiment, the received interrupt request is held in the control device 100 until the elements (such as the CPU 121 and the memory 122) constituting the processing device 120 complete the change to the operating mode, and when the elements have completed the change to the operating mode, the sending unit 70 sends the interrupt request held until then to the processing device 120. The method for holding the interrupt request may be any method. For example, the received interrupt request may be temporarily stored in a memory (not illustrated) or may be held by starting a program associated with the interrupt request.

A configuration in which power supply by the power supply unit 130 is started when the processing device 120 receives an interrupt request is also possible. With this configuration, an interrupt signal can be sent instead of the return signal described above. Alternatively, in a configuration in which power supply by the power supply unit 130 is not started when an interrupt request is received, the interrupt request may be sent to the processing device 120 at the same time as sending the return signal described above, or after sending the return signal and before the return completion time.

Note that, in the example of FIG. 5, the time Z corresponding to an end point of the element (the memory 122 in the example of FIG. 5) with the longest start-up time of a plurality of elements constituting the processing device 120 is the return completion time of the elements. In the example of FIG. 5, the deciding unit 50 notifies the sending unit 70 that the return completion time of the elements is reached when the time Z is reached. The sending unit 70 that has received the notification then sends the held interrupt request to the processing device 120.

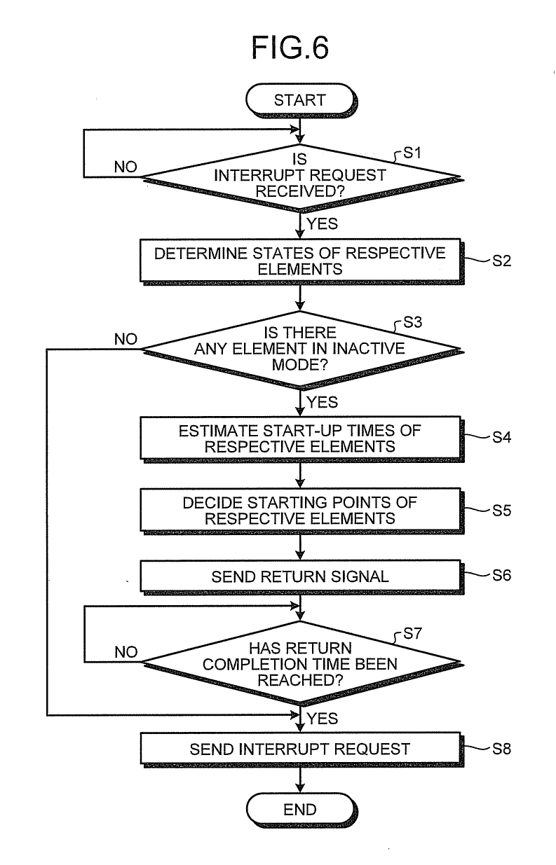

Next, an example of operation of the control device 100 according to this embodiment will be described. FIG. 6 is a flowchart illustrating an example of processing operation of the control device 100 according to this embodiment. As illustrated in FIG. 6, first, when an interrupt request is received by the receiving unit 10 (result of step S1: YES), the judging unit 20 judges the state of each of a plurality of elements (such as the CPU 121 and the memory 122) constituting the processing device 120 (step S2). More specifically, the judgment is made as follows. When the judging unit 20 has the configuration of FIG. 2, the estimating unit 40 requests the state detecting section 22 to notify the states of the elements constituting the processing device 120. The state detecting section 22 that has received the request accesses the elements constituting the processing device 120 to detect (judges) the states of the elements and notifies the estimating unit 40 of the detection results. The estimating unit 40 judges in which of the operating mode and the inactive mode each of the elements constituting the processing device 120 is on the basis of the detection results notified from the state detecting section 22. Alternatively, when the judging unit 20 has the configuration of FIG. 3, the estimating unit 40 reads out the state information held by the holding section 26 and judges which of the operating mode and the inactive mode each of the elements constituting the processing device 120 is on the basis of the read state information.

Next, the estimating unit 40 determines whether there is any element judged to be in the inactive mode in step S2 in the elements constituting the processing device 120 (step S3). If there is no element judged to be in the inactive mode (result of step S3: NO), all the elements constituting the processing device 120 are in an immediately operable state and the sending unit 70 thus sends the interrupt request received in step Si to the processing device 120 (step S8).

If there is an element judged to be in the inactive mode (result of step S3: YES), on the other hand, the estimating unit 40 estimates the start-up times of the elements constituting the processing device 120 (step S4). More specifically, the estimating unit 40 estimates the start-up time of each element by reading the start-up time associated with the current mode of the element from the first storage unit 30. Next, the deciding unit 50 decides the starting point of each element on the basis of the difference between start-up times of the elements (step S5). The method for deciding the starting points of the elements is as described above.

Next, when the starting point of each element is reached, the directing unit 60 sends the return signal of the element to the power supply unit 130 (step S6). The method for sending the return signal is as described above. Next, if it is judged that the return completion time has been reached (result of step S7: YES), the deciding unit 50 notifies the sending unit 70 that the return completion time has been reached. The sending unit 70 that has received the notification then sends the interrupt request received in step Si to the processing device 120 (step S8). The processing by the control device 100 ends here.

As described above, in this embodiment, upon receiving an interrupt request, the control device 100 estimates the start-up time of each of a plurality of elements constituting the processing device 120 on the basis of the current state of each element. The control device 100 then decides the timing (starting point in time) at which power supply for changing to the operating mode is to be started for each element on the basis of a difference between the start-up times of the elements. More specifically, the control device 100 decides the starting points of the respective elements so that the starting points of the elements other than the reference element are later than the starting point of the reference element according to differences between the start-up time of the reference element and the start-up times of the other elements, which produces an advantageous effect that wasteful power consumption can be reduced as compared to a case where the starting points of the respective elements are the same. Moreover, in this embodiment, since the control device 100 decides the starting points of the respective elements so that the return completion times of the respective elements are the same, the element with the shortest start-up time does not have to wait until the other elements complete the change to the operating mode after completing the change to the operating mode. Wasteful power consumption can therefore be further reduced.

Second Embodiment

Next, the second embodiment will be described. In the second embodiment, the control device 100 sends the received interrupt request to the processing device 120 if the processing device 120 is in an active state (operating state) in which the processing device 120 is executing a process or sends the received interrupt request to the processing device 120 only when a predetermined condition is satisfied if the processing device 120 is in an idle state in which the processing device 120 is not executing any processes. Specific details will be hereinafter described. Parts that are the same as those in the first embodiment will be designated by the same reference numerals and description thereof will not be repeated as appropriate.

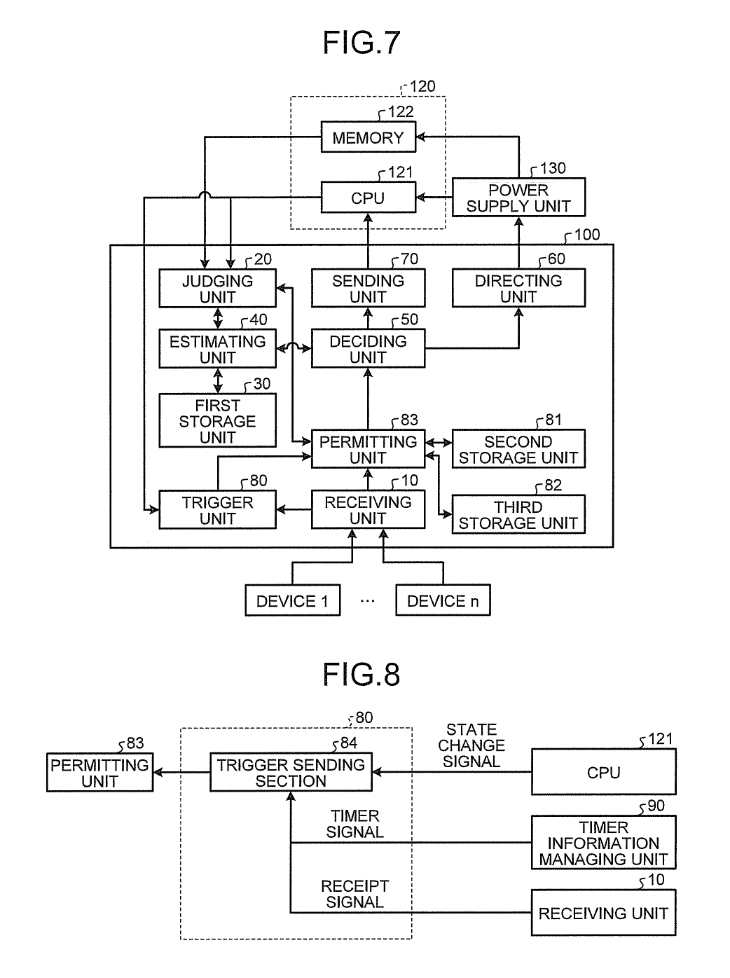

FIG. 7 is a block diagram illustrating an example of the control device 100 according to the second embodiment. As illustrated in FIG. 7, the control device 100 is different from the first embodiment in that the control device 100 further includes a trigger unit 80, a second storage unit 81, a third storage unit 82 and a permitting unit 83.

The trigger unit 80 activates the permitting unit 83 when a certain condition is satisfied. FIG. 8 is a block diagram illustrating an example of a configuration of the trigger unit 80. As illustrated in FIG. 8, the trigger unit 80 includes a trigger sending section 84. The trigger sending section 84 sends a trigger signal for activating the permitting unit 83 to the permitting unit 83 when the trigger sending section 84 is notified of a change in the state of the processing device 120 by the CPU 121. The CPU 121 notifies the trigger sending section 84 of a state change signal for informing a state change when the processing device 120 changes from the active state to the idle state or from the idle state to the active state.

The trigger sending section 84 also sends a trigger signal to the permitting unit 83 each time a time indicated by timer information indicating at least one time is reached. The timer information is stored in a memory (not illustrated) included in an external timer information managing unit 90. The timer information managing unit 90 notifies the trigger sending section 84 of a timer signal for informing that the time is reached each time the time indicated by the timer information is reached. While the timer information managing unit 90 is provided outside the control device 100 in this example, the timer information managing unit 90 is not limited thereto and may alternatively be mounted on the control device 100.

The trigger sending section 84 further sends a trigger signal to the permitting unit 83 when the trigger sending section 84 is notified of receipt of an interrupt request by the receiving unit 10. The receiving unit 10 notifies the trigger sending section 84 of a receipt signal for informing receipt of an interrupt request when the receiving unit 10 has received an interrupt request from devices 1 to n. In this manner, the trigger unit 80 according to this embodiment activates the permitting unit 83, which is triggered when a state change signal is received from the CPU 121, when a timer signal is received from the timer information managing unit 90 or when a receipt signal is received from the receiving unit 10.

While the trigger sending section 84 decides whether or not to send a trigger signal in response to each of a state change signal, a timer signal and a receipt signal described above herein, the trigger sending section 84 may alternatively decide whether or not to send a trigger signal in response to any one or any two of a state change signal, a timer signal and a receipt signal, for example. Basically, the trigger sending section 84 can decide whether or not to send a trigger signal in response to at least one of a state change signal, a timer signal and a receipt signal described above.

The description is continued referring back to FIG. 7. The judging unit 20 of this embodiment judges whether the processing device 120 is in the active state or the idle state in addition to the functions described above. In this embodiment, in the operating mode described above, an active mode representing a state in which an element is operating and a standby mode in which the element is waiting in an operable state are separately set, and the judging unit 20 judges whether the processing device 120 is in the active state (operating state) or in the idle state on the basis of the modes of the elements.

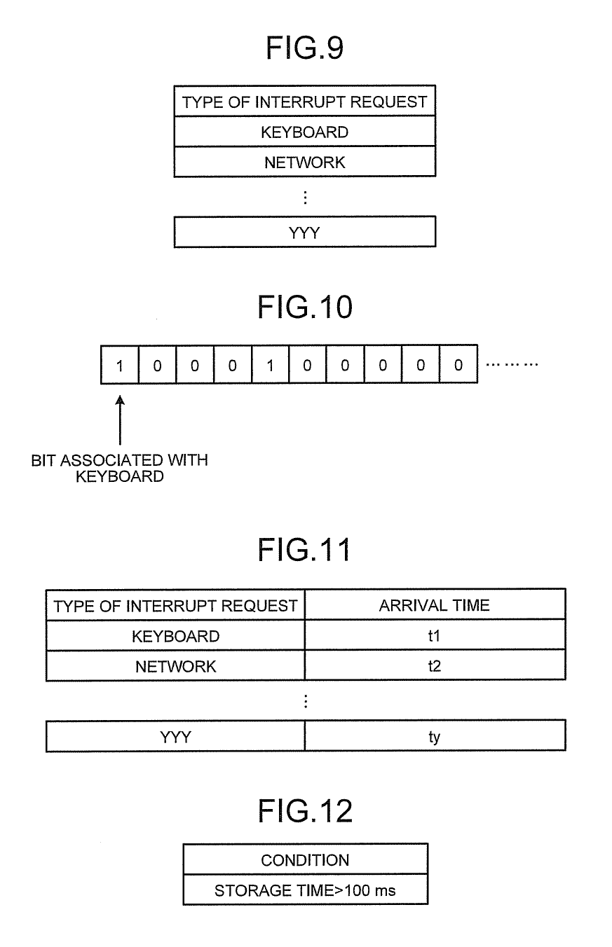

The second storage unit 81 stores the interrupt request received by the receiving unit 10. FIG. 9 is a diagram illustrating an example of information stored in the second storage unit 81. In the example of FIG. 9, “KEYBOARD” represents an interrupt request caused by an input to a keyboard, and “NETWORK” represents an interrupt request caused by packet transmission/reception from/to a communication interface unit. Alternatively, the second storage unit 81 can store bits associated with the respective devices as illustrated in FIG. 10, for example. For example, when a bit associated with the “KEYBOARD” is “1”, this means that an interrupt request caused by an input to the keyboard is held by the second storage unit 81. Basically, the second storage unit 81 may be in any form that stores information for identifying interrupt requests. When a permission condition, which will be described later, is judged on the basis of a storage time representing the length of time for which an interrupt request is kept stored in the second storage unit 81, the second storage unit 81 stores an interrupt request and the time (arrival time) at which the interrupt request was received in association with each other as illustrated in FIG. 11. When a permission condition is judged on the basis of a type of a source device of an interrupt request and a storage time of the device, for example, the arrival time of each interrupt request needs to be stored, while when a permission condition is judged only on the basis of a storage time for any type of the source device of an interrupt request, only the arrival time of the interrupt request that arrives first may be stored.

The third storage unit 82 stores a permission condition indicating a condition under which sending of an interrupt request is permitted. FIG. 12 illustrates an example of the permission condition stored in the third storage unit 82. In the example of FIG. 12, the permission condition is that a storage time representing a length of time for which an interrupt request is kept stored in the second storage unit 81 exceeds 100 ms. In the example of FIG. 12, when a plurality of interrupt requests is stored in the second storage unit 81, the permission condition is satisfied at a point when the storage time of the first stored interrupt request exceeds 100 ms.

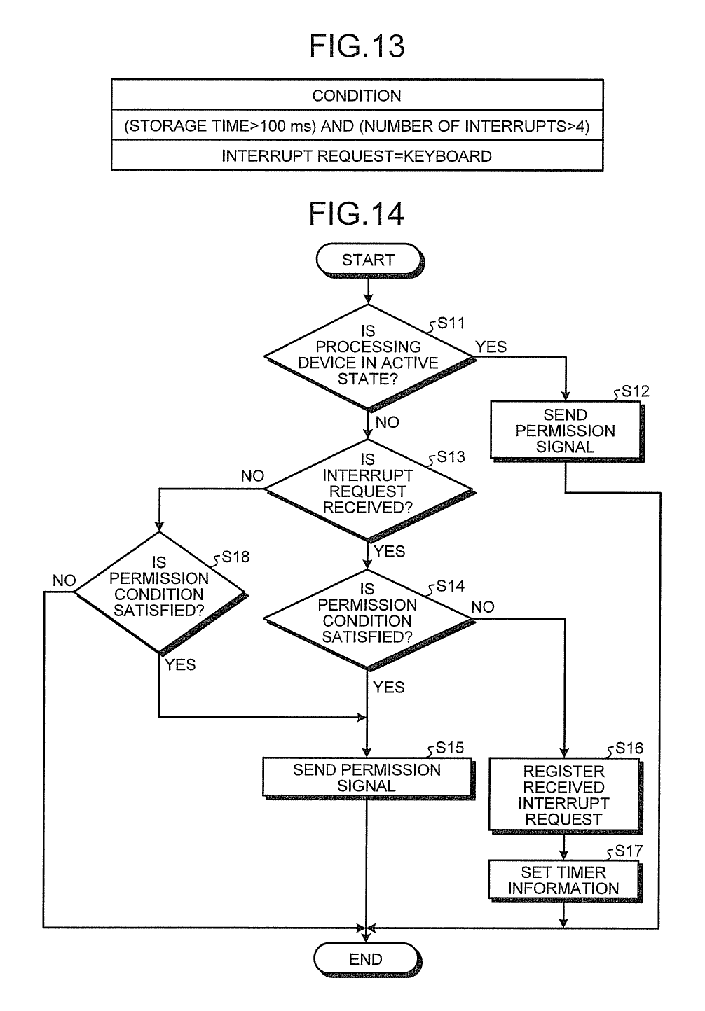

Note that the permission condition is not limited thereto, and any type of permission condition may be stored in the third storage unit 82. For example, the third storage unit 82 may store a permission condition in FIG. 13. In the example of FIG. 13, the third storage unit 82 stores two conditions, and the permission condition is satisfied if either one of the two conditions is satisfied. In other words, whether the permission condition is satisfied is judged on the basis of a logical sum of the two conditions. Note that the judgment of the permission condition is not limited thereto, and whether the permission condition is satisfied may alternatively be judged on the basis a logical product of two conditions, for example. Any number and any types of conditions may be used to obtain a logical sum or a logical product. In the example of FIG. 13, the upper condition is that the storage time exceeds 100 ms and, at the same time, the number of interrupt requests stored in the second storage unit 81 is more than four. On the other hand, the lower condition is that an interrupt request caused by an input to a keyboard is stored in the second storage unit 81.

The permitting unit 83 initiates operation upon receipt of the trigger signal described above. The permitting unit 83 performs a permission process of deciding whether or not to permit to send an interrupt request to the processing device 120.

FIG. 14 is a flowchart illustrating an example of the permission process performed by the permitting unit 83. First, the permitting unit 83 judges whether or not the processing device 120 is in the active state (step S11). If the processing device 120 is judged to be in the active state (operating state) (result of step S11: YES), the permitting unit 83 sends to the deciding unit 50 a permission signal permitting to send an interrupt request store in the second storage unit 81 to the processing device 120 (step S12). If the permitting unit 83 has initiated operation which is triggered by receipt of an interrupt request by the receiving unit 10, the permitting unit 83 sends to the deciding unit 50 a permission signal permitting to send the received interrupt request to the processing device 120. The permission process is then terminated and the operation of the permitting unit 83 is stopped.

If the processing device 120 is judged to be in the idle state (result of step S11: NO), on the other hand, the permitting unit 83 checks whether or not the initiation of the operation is triggered by receipt of an interrupt request by the receiving unit 10. In other words, the permitting unit 83 checks whether or not an interrupt request is received by the receiving unit 10 (step S13).

If the result of step S13 is positive, the permitting unit 83 refers to the permission condition stored in the third storage unit 82 and judges whether or not the permission condition is satisfied (step S14). In this embodiment, it is assumed that the third storage unit 82 stores the permission condition illustrated in FIG. 12. If the result of step S14 is positive, the permitting unit 83 sends to the deciding unit 50 a permission signal permitting to send the interrupt request stored in the second storage unit 81 and the interrupt request received by the receiving unit 10 to the processing device 120 (step S15). The permission process is then terminated and the operation of the permitting unit 83 is stopped.

If the result of step S14 described above is negative, the permitting unit 83 registers the interrupt request received by the receiving unit 10 in the second storage unit 81 (step S16), and starts measuring the storage time of the registered interrupt request. Note that although it is judged whether or not the permission condition is satisfied without registering the interrupt request received by the receiving unit 10 in the second storage unit 81 in step S14 described above, the operation is not limited thereto. It may alternatively be judged whether or not the permission condition is satisfied after the interrupt request received by the receiving unit 10 is registered in the second storage unit 81.

Then, the permitting unit 83 sets timer information according to a result of comparison between a time when the storage time of the interrupt request first stored in the second storage unit 81 exceeds 100 ms (a time when the permission condition in FIG. 12 is satisfied) and the next time indicated by the timer information (step S17). More specifically, the permitting unit 83 sets the time when the storage time of the interrupt request exceeds 100 ms as the next time to be indicated by the timer information if the time when the storage time of the interrupt request exceeds 100 ms is earlier than the next time indicated by the timer information. The permitting unit 83 then notifies the timer information managing unit 90 of the set timer information. As a result, when the next time indicated by the timer information is reached, the permission condition will be satisfied at the same time. When step S17 is completed, the permission process is terminated and the operation of the permitting unit 83 is stopped.

If the result of step S13 described above is negative, on the other hand, the permitting unit 83 also judges whether or not the permission condition is satisfied (step S18). Then, if the result of step S18 is positive, the process proceeds to step S15 described above. If the result of step S18 is negative, the permission process is terminated and the operation of the permitting unit 83 is stopped.

In this embodiment, the processing operation in FIG. 6 is performed, which is triggered when the deciding unit 50 receives a permission signal from the permitting unit 83. In this case, the process is started from step S2 in FIG. 6 but the subsequent steps are the same as those in the first embodiment. Thus, detailed description thereof will not be repeated.

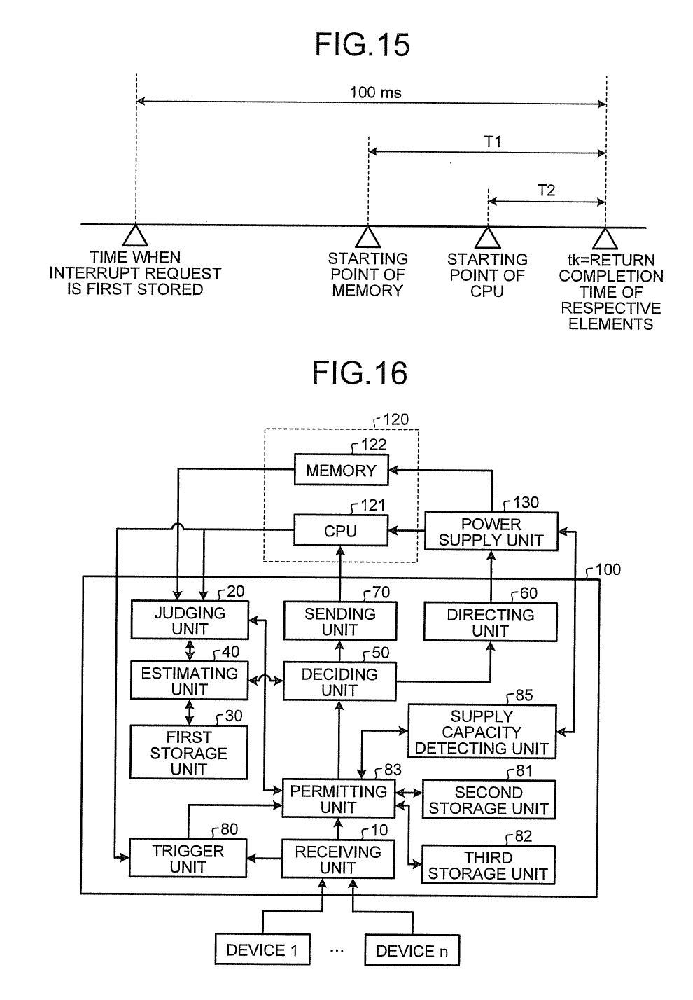

Alternatively, the permitting unit 83 may notify the deciding unit 50 in advance the time when the storage time of the first interrupt request stored in the second storage unit 81 exceeds 100 ms (the time when the storage time is over a predetermined value and the permission condition is satisfied), and the deciding unit 50 may decide the starting point of each of the elements constituting the processing device 120 so that the starting points of the elements are earlier than the notified time. In this case, the processing operation (the processing operation in step S2 and subsequent steps) in FIG. 6 is triggered when the deciding unit 50 receives the notification of the aforementioned time (the time when the storage time is over a predetermined value and the permission condition is satisfied) from the permitting unit 83. As illustrated in FIG. 15, for example, the deciding unit 50 can also decide the starting point of each element so that the time tk when the storage time of the first interrupt request stored in the second storage unit 81 exceeds 100 ms becomes the return completion time of the respective elements. Note that a case where the CPU 121 and the memory 122 are judged to be in the inactive mode in step S2 of FIG. 6 is assumed in the example of FIG. 15.

Third Embodiment

A third embodiment is different from the second embodiment in that employed is a permission condition that power supply capacity of the processing device 120, the control device 100, and equipment on which the respective devices are mounted (for example, terminal equipment such as PCs) exceeds a threshold. Specific details will be hereinafter described. Parts that are the same as those in the second embodiment will be designated by the same reference numerals and description thereof will not be repeated as appropriate.

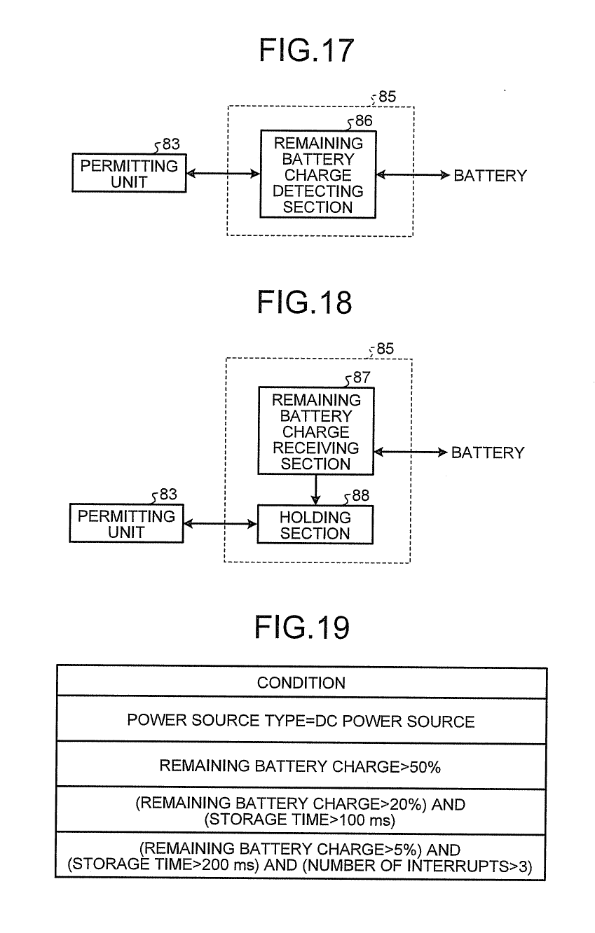

FIG. 16 is a block diagram illustrating an example of a schematic configuration of the control device 100 according to the third embodiment. The control device 100 is different from that in the second embodiment in that a supply capacity detecting unit 85 is further included. The supply capacity detecting unit 85 detects power supply capacity of the power supply unit 130. In this embodiment, the supply capacity detecting unit 85 detects a total amount of charge (referred to as remaining battery charge) remaining in a battery (not illustrated) that is a power source of the power supply unit 130. As illustrated in FIG. 17, for example, the supply capacity detecting unit 85 may include a remaining battery charge detecting section 86. In the example of FIG. 17, the remaining battery charge detecting section 86 accesses the battery (not illustrated) to detect the remaining battery charge in response to a request from the permitting unit 83, and notifies the permitting unit 83 of the detected remaining battery charge.

Alternatively, the supply capacity detecting unit 85 may include a remaining battery charge receiving section 87 and a holding section 88 as illustrated in FIG. 18, for example. In the example of FIG. 18, the remaining battery charge receiving section 87 receives the remaining battery charge from the battery (not illustrated), and makes the holding section 88 hold the received remaining battery charge. The remaining battery charge held by the holding section 88 is updated each time the remaining battery charge receiving section 87 receives the remaining battery charge. The permitting unit 83 can know the remaining battery charge by reading out the remaining battery charge held by the holding section 88.

FIG. 19 is a diagram illustrating an example of a permission condition stored in the third storage unit 82 according to the third embodiment. In the example of FIG. 19, the third storage unit 82 stores four conditions, and the permission condition is satisfied if any one of the four conditions is satisfied. In the example of FIG. 19, a condition in the first row is that the type of the power source is a DC power source (direct current power source). A condition in the second row is that the remaining battery charge is over 50%. A condition in the third row is that the remaining battery charge is over 20% and, at the same time, the storage time exceeds 100 ms. A condition in the fourth row is that the remaining battery charge is over 5%, the storage time exceeds 200 ms and the number of interrupt requests stored in the second storage unit 81 is more than three.

Next, the permission process performed by the permitting unit 83 will be described with reference to FIG. 14. When the supply capacity detecting unit 85 has the configuration of FIG. 17, the permitting unit 83 requests the supply capacity detecting unit 85 to notify the remaining battery charge in each of step1 S14 and S18 in FIG. 14. The remaining battery charge detecting section 86 that has received the request accesses the battery (not illustrated) to detect the remaining battery charge, and notifies the permitting unit 83 of the detected remaining battery charge. The permitting unit 83 judges whether or not the permission condition stored in the third storage unit 82 is satisfied on the basis of the remaining battery charge notified by the remaining battery charge detecting section 86, the storage time of the interrupt request stored in the second storage unit 81 and the number of interrupt requests.

Alternatively, when the supply capacity detecting unit 85 has the configuration of FIG. 18, the permitting unit 83 reads out the remaining battery charge held by the holding section 88, and judges whether or not the permission condition stored in the third storage unit 82 is satisfied on the basis of the read remaining battery charge, the storage time of the interrupt request stored in the second storage unit 81 and the number of the interrupt requests in each of steps S14 and S18 in FIG. 14. Since the other processes are similar to those in the second embodiment, detailed description thereof will not be repeated.

When the remaining battery charge detected by the supply capacity detecting unit 85 is lower than a predetermined reference value, the permitting unit 83 may alternatively discard the received interrupt request without registering the same in the second storage unit 81 or permitting to send the same to the processing device 120.

Modified Examples

While certain embodiments have been described, the embodiments described above have been presented by way of example only and are not intended to limit the scope of the inventions. These novel embodiments can be embodied in a variety of other forms, and various omissions, substitutions and changes can be made without departing from the spirit of the inventions. The accompanying claims and their equivalents are intended to cover such forms or modifications as would fall within the scope and spirits of the inventions.

(1) Modified Example 1

Any types and any number of elements may constitute the processing device 120. For example, a display unit having a function of displaying various information may be included in the elements constituting the processing device 120. Any types of modes of the elements constituting the processing device 120 may be used. For example, the “inactive mode” described above may be further divided into a plurality of modes according to power consumption of the elements. The “operating mode” described above may be divided into an active mode representing a state in which an element is actually operating and a standby mode in which the element is waiting in an operable state. In addition, the start-up times associated with the respective modes are set in advance. Basically, it is sufficient that, for each of the elements constituting the processing device 120, a mode of the element and the start-up time are stored in association with each other in the first storage unit 30.

(2) Modified Example 2

The control device 100 can also specify elements to be activated according to the type of the interrupt request received by the receiving unit 10, for example. When the memory 122 is not needed for an interrupt process requested to be performed by the received interrupt request, for example, the control device 100 does not directs the power supply unit 130 to supply power to the memory 122. Thus, the deciding unit 50 may also decide the starting points of elements required for the interrupt process requested to be performed by the received interrupt request out of a plurality of elements constituting the processing device 120 but does not decide the starting points of the other elements (elements unnecessary for the interrupt process).

(3) Modified Example 3

The interrupt request received by the receiving unit 10 may be output from any source, which is not limited to the devices 1 to n described above. For example, the control device 100 may include a polling unit that periodically polls the devices 1 to n for the states thereof and outputs a signal (that is, an interrupt request) requesting to execute an interrupt process when a state change that is a trigger for executing the interrupt process is detected, the polling unit being the source of the interrupt request. Basically, the interrupt request received by the receiving unit 10 may be one output from outside or one output from inside.

(4) Modified Example 4

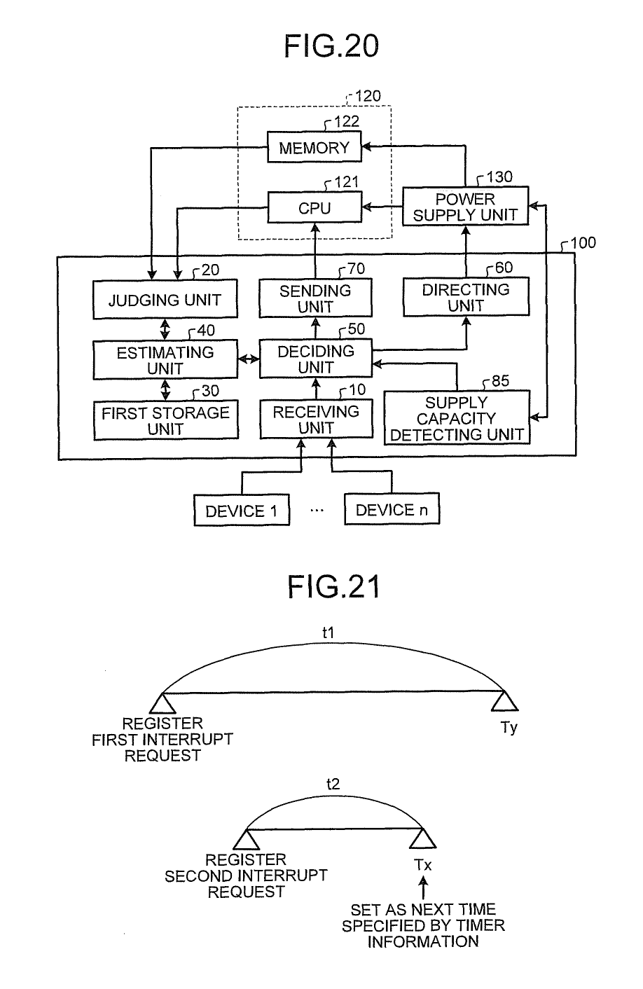

As illustrated in FIG. 20, the supply capacity detecting unit 85 described above may be provided in the control device 100 in the first embodiment. When the supply capacity detecting unit 85 has the configuration of FIG. 17, the deciding unit 50 requests the remaining battery charge detecting section 86 to notify the remaining battery charge upon receipt of the interrupt request by the receiving unit 10. The remaining battery charge detecting section 86 that has received the request accesses the battery to detect the remaining battery charge, and notifies the deciding unit 50 of the detected remaining battery charge.

Alternatively, when the supply capacity detecting unit 85 has the configuration of FIG. 18, the deciding unit 50 reads out the remaining battery charge held by the holding section 88 upon receipt of the interrupt request by the receiving unit 10. When the remaining battery charge detected by the supply capacity detecting unit 85 is lower than a predetermined reference value, the deciding unit 50 decides not to send the received interrupt request to the processing device 120. That is, an interrupt request received during a state in which the power supply capacity of the power supply unit 130 is lower than a predetermined reference value is discarded without being sent to the processing device 120.

(5) Modified Example 5

Any permission condition may be stored in the third storage unit 82 described above. For example, a permission condition that the number of interrupt requests is two may be used. Hereinafter, an example in which an interrupt request (referred to as a first interrupt request) is sent to the control device 100 of the second embodiment and then another interrupt request (referred to as a second interrupt request) is sent thereto in a state in which no interrupt request is present in the second storage unit 81 will be described (also refer to FIG. 14).

First, when the first interrupt request is received by the receiving unit 10, the permitting unit 83 starts to operate and performs the permission process described above. The processing device 120 is assumed to be in the idle state at this time. Accordingly, the result of step S11 in FIG. 14 is negative and the result of step S13 is positive. The process thus proceeds to step S14. At this point, since no interrupt request is stored in the second storage unit 81 and only the first interrupt request is received, the number of interrupt requests is “1”, and the aforementioned permission condition (the number of interrupt requests is two) is not satisfied. The process thus proceeds to step S16. If the processing device 120 is in the active state (if the result of step S11 in FIG. 14 is positive), the permitting unit 83 sends to the deciding unit 50 a permission signal permitting to send the first interrupt request to the processing device 120 (step S12 in FIG. 14).

In step S16, the permitting unit 83 registers the first interrupt request received by the receiving unit 10 in the second storage unit 81. In this example, the permission process is terminated without performing the process in step S17 in FIG. 13 and the operation of the permitting unit 83 is stopped.

Then, when the second interrupt request is received by the receiving unit 10, the permitting unit 83 starts to operate and performs the permission process described above. The processing device 120 is assumed to be in the idle state similarly to the above. Accordingly, the result of step S11 is negative, the result of step S13 is positive, and the process thus proceeds to step S14. At this point, since the first interrupt request is stored in the second storage unit 81 and the second interrupt request is received by the receiving unit 10, the number of interrupt requests is “2”, which satisfies the aforementioned permission condition. Accordingly, the process proceeds to step S15 where the permitting unit 83 sends to the deciding unit 50 a permission signal permitting to send the received second interrupt request and the first interrupt request stored in the second storage unit 81 to the processing device 120. Note that, if the processing device 120 is in the active state (if the result of step S11 in FIG. 14 is positive), the permitting unit 83 also sends to the deciding unit 50 a permission signal permitting to send the received second interrupt request and the first interrupt request stored in the second storage unit 81 to the processing device 120 (step S12 in FIG. 14).

(6) Modified Example 6

For example, a storage time at which the permission condition is satisfied (referred to as a threshold time) may be set individually for each interrupt request. A case where a threshold time associated with an first interrupt request caused by an input to a keyboard is set to t1 and a threshold time associated with an second interrupt request caused by an input to a mouse is set to t2 (<t1) is assumed here. In this case, the permission condition is assumed to be that a storage time of any one interrupt request stored in the second storage unit 81 exceeds the threshold time associated with the interrupt request.

Hereinafter, an example in which the aforementioned first interrupt request is sent to the control device 100 of the second embodiment and then the aforementioned second interrupt request is sent thereto in a state in which no interrupt request is present in the second storage unit 81 will be described (also refer to FIG. 14). First, when the first interrupt request is received by the receiving unit 10, the control device 100 starts to operate and performs the permission process described above. The processing device 120 is assumed to be in the idle state at this time. Accordingly, the result of step S11 in FIG. 14 is negative, the result of step S13 is positive, and the process thus proceeds to step S14. At this point, since no interrupt request is present in the second storage unit 81, the aforementioned permission condition is not satisfied, and the process thus proceeds to step S16. If the processing device 120 is in the active state (if the result of step S11 in FIG. 14 is positive), the permitting unit 83 sends to the deciding unit 50 a permission signal permitting to send the received first interrupt request to the processing device 120 (step S12 in FIG. 14).

In step S16, the permitting unit 83 registers the first interrupt request received by the receiving unit 10 in the second storage unit 81. In this example, an interrupt request and a threshold time of the interrupt request are stored in association with each other in the second storage unit 81. Next, the permitting unit 83 sets timer information according to a result of comparison between a time when the storage time of the first interrupt request exceeds the threshold time t1 associated therewith and the next time indicated by the timer information (step S17). It is assumed here that the time at which the storage time of the first interrupt request exceeds the threshold time t1 associated therewith is earlier than the next time indicated by the timer information. Accordingly, the permitting unit 83 sets the time at which the storage time of the first interrupt request exceeds the threshold time t1 associated therewith, namely the time at which a length of time t1 has passed from the current time, as the next time to be indicated by the timer information. The permission process is then terminated and the operation of the permitting unit 83 is stopped.

Then, when the second interrupt request is received by the receiving unit 10, the permitting unit 83 starts to operate and performs the permission process described above. The processing device 120 is assumed to be in the idle state similarly to the above. Accordingly, the result of step S11 is negative, the result of step S13 is positive, and the process thus proceeds to step S14. It is assumed here that the first interrupt request is stored in the second storage unit 81 and the storage time of the first interrupt request has not exceeded the threshold time t1 associated with the first interrupt request. Accordingly, the permission condition is not satisfied and the process proceeds to step S16. If the processing device 120 is in the active state (if the result of step S11 is positive), the permitting unit 83 sends to the deciding unit 50 a permission signal permitting to send the received second interrupt request and the first interrupt request stored in the second storage unit 81 to the processing device 120 (step S12 in FIG. 14).

In step S16, the permitting unit 83 registers the second interrupt request received by the receiving unit 10 in the second storage unit 81. Next, the permitting unit 83 sets timer information according to a result of comparison between a time when the storage time of the second interrupt request exceeds the threshold time t2 associated therewith and the next time indicated by the timer information, that is, a time when the storage time of the first interrupt request exceeds the threshold time t1 (step S17). It is assumed here that the time Tx at which the storage time of the second interrupt request exceeds the threshold time t2 is earlier than the time Ty at which the storage time of the first interrupt request exceeds the threshold time t1 as illustrated in FIG. 21. The permitting unit 83 therefore sets the time Tx illustrated in FIG. 21 as the next time to be indicated by the timer information. When the time Tx is reached thereafter, the permission condition will be satisfied at the same time.

(7) Modified Example 7

A permission condition may be that an idle time representing a length of time for which the idle state of the processing device 120 continues exceeds a predetermined value, for example. In this case, a storage unit that stores a time when the processing device 120 enters the idle state, for example, is provided, and when the estimating unit 40 detects that the processing device 120 has entered the idle state from the active state (operating state), the estimating unit 40 writes the time in the storage unit. As an example, a permission condition may be that the idle time is 100 ms or longer. According to this modified example, when the processing device 120 has continued to be in the idle state for a sufficiently long time and a sufficient power saving effect is obtained, a permission signal can be output immediately in response to arrival of an interrupt request.

(8) Modified Example 8

While the power source of the power supply unit 130 is a battery, the power source is not limited thereto and any type of power source may be used. For example, the power source may be solar cells or the like.

When the power source is solar cells or the like in the third embodiment described above, a permission condition may be set by using the generated voltage, the generated current or the like of the solar cells. Basically, the permission condition may be any condition that power supply capacity exceeds a threshold.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device comprising:
a receiving unit configured to receive an interrupt request requesting a processing device that includes a plurality of elements capable of being individually subjected to voltage control to execute an interrupt process;
a judging unit configured to judge a state of each of the elements;
an estimating unit configured to estimate, for each of the elements, a start-up time representing a time required for the element to change into an operating mode representing an operable state after power is supplied on basis of a result of judgment by the judging unit;
a deciding unit configured to decide, for each of the elements, a starting point in time representing a timing at which power supply is to be started on basis of a difference in the start-up times between the elements;
a directing unit configured to direct a power supply unit for supplying power to the elements to perform power supply according to the starting point decided by the deciding unit; and
a sending unit configured to send the interrupt request to the processing device.

2. The control device according to claim 1, wherein
the deciding unit decides the starting point of each of the elements so that the starting points of elements other than a reference element, the reference element representing an element having the longest start-up time, are later than the starting point of the reference element, according to a difference between the start-up time of the reference element and the start-up times of the other elements.

3. The control device according to claim 2, wherein
the deciding unit decides the starting point of each of the elements so that the elements complete to change into the operating mode at the same time.

4. The control device according to claim 1, further comprising
a first storage unit configured to store, for each of the elements, a mode representing a state of the element and the start-up time in association with each other, wherein
the estimating unit estimates the start-up time of each of the elements by reading out the start-up time associated with the mode of the element from the first storage unit.

5. The control device according to claim 1, wherein
the sending unit sends the received interrupt request to the processing device when the elements have completed to change into the operating mode.

6. The control device according to claim 1, wherein,
the deciding unit decides the starting points of elements required for the interrupt process requested to be executed by the received interrupt request out of the plurality of elements without deciding the starting points of the other elements.

7. The control device according to claim 1, further comprising
a supply capacity detecting unit configured to detect power supply capacity of the power supply unit, wherein
when the interrupt request is received in a state in which the power supply capacity of the power supply unit is lower than a reference value, the interrupt request is discarded without being sent to the processing device.

8. The control device according to claim 1, further comprising:
a second storage unit configured to store the interrupt request; and
a permitting unit configured
to register the interrupt request received by the receiving unit when the judging unit judges that the processing device is in an idle state in which the processing device is not executing any process and a predetermined condition is not satisfied, and
to permit to send the interrupt request stored in the second storage unit to the processing device when the predetermined condition is satisfied or when the processing device is judged to be in an operating state.

9. The control device according to claim 8, wherein
the predetermined condition is that a storage time representing a length of time for which the interrupt request is kept stored in the second storage unit exceeds a predetermined value.

10. The control device according to claim 8, wherein
the predetermined condition is that an idle time representing a length of time for which the idle state continues exceeds a predetermined value.

11. The control device according to claim 9, wherein
the deciding unit decides the starting point of each of the elements so that the starting points of the elements are earlier than a time at which the storage time exceeds the predetermined value.

12. The control device according to claim 11, wherein
the deciding unit decides the starting point of each of the elements so that the elements complete to change into the operating mode when a time at which the storage time exceeds the predetermined value is reached.

13. A computer program product comprising a computer-readable medium including programmed instructions for interrupt controlling, wherein the instructions, when executed by a computer, cause the computer to perform:
receiving an interrupt request requesting a processing device that includes a plurality of elements capable of being individually subjected to voltage control to execute an interrupt process;
judging a state of each of the elements;
estimating, for each of the elements, a start-up time representing a time required for the element to change into an operating mode representing an operable state after power is supplied on basis of a result of judgment at the judging;
deciding, for each of the elements, a starting point in time representing a timing at which power supply is to be started on basis of a difference in the start-up times between the elements;
directing a power supply unit for supplying power to the elements to perform power supply according to the starting point; and
sending the interrupt request to the processing device.

14. A control device comprising:
a receiving unit configured to receive an interrupt request requesting a processing device that includes a plurality of elements capable of being individually subjected to power supply control to execute an interrupt process;
a judging unit configured to judge a state of each of the elements;
an estimating unit configured to estimate, for each of the elements, a start-up time representing a time required for the element to change into an operating mode representing an operable state after power is supplied on basis of a result of judgment by the judging unit;
a deciding unit configured to decide, for each of the elements, a starting point in time representing a timing at which power supply is to be started on basis of a difference in the start-up times between the elements;
a directing unit configured to direct a power supply unit for supplying power to the elements to perform power supply according to the starting point decided by the deciding unit; and
a sending unit configured to send the interrupt request to the processing device.

15. The control device according to claim 14, wherein
the deciding unit decides the starting point of each of the elements so that the starting points of elements other than a reference element, the reference element representing an element having the longest start-up time, are later than the starting point of the reference element, according to a difference between the start-up time of the reference element and the start-up times of the other elements.

16. The control device according to claim 15, wherein
the deciding unit decides the starting point of each of the elements so that the elements complete to change into the operating mode at the same time.

17. The control device according to claim 14, further comprising
a first storage unit configured to store, for each of the elements, a mode representing a state of the element and the start-up time in association with each other, wherein
the estimating unit estimates the start-up time of each of the elements by reading out the start-up time associated with the mode of the element from the first storage unit.

18. The control device according to claim 14, wherein
the sending unit sends the received interrupt request to the processing device when the elements have completed to change into the operating mode.

19. The control device according to claim 14, wherein,
the deciding unit decides the starting points of elements required for the interrupt process requested to be executed by the received interrupt request out of the plurality of elements without deciding the starting points of the other elements.

20. The control device according to claim 14, further comprising
a supply capacity detecting unit configured to detect power supply capacity of the power supply unit, wherein
when the interrupt request is received in a state in which the power supply capacity of the power supply unit is lower than a reference value, the interrupt request is discarded without being sent to the processing device.

21. The control device according to claim 14, further comprising:
a second storage unit configured to store the interrupt request; and
a permitting unit configured
to register the interrupt request received by the receiving unit when the judging unit judges that the processing device is in an idle state in which the processing device is not executing any process and a predetermined condition is not satisfied, and
to permit to send the interrupt request stored in the second storage unit to the processing device when the predetermined condition is satisfied or when the processing device is judged to be in an operating state.

22. The control device according to claim 21, wherein
the predetermined condition is that a storage time representing a length of time for which the interrupt request is kept stored in the second storage unit exceeds a predetermined value.

23. The control device according to claim 21, wherein
the predetermined condition is that an idle time representing a length of time for which the idle state continues exceeds a predetermined value.

24. The control device according to claim 22, wherein
the deciding unit decides the starting point of each of the elements so that the starting points of the elements are earlier than a time at which the storage time exceeds the predetermined value.

25. The control device according to claim 24, wherein
the deciding unit decides the starting point of each of the elements so that the elements complete to change into the operating mode when a time at which the storage time exceeds the predetermined value is reached.
